(19) United States
(12) Patent Application Publication
(10) Pub. No.: US 2013/0240465 A1
(43) Pub. Date: Sep. 19, 2013

(54) Carrier Tray of Liquid Crystal Panel

(71) Applicant: Ying Wu, Shenzhen City (CN)

(72) Inventor: Ying Wu, Shenzhen City (CN)

(73) Assignee: Shenzhen China Star Optoelectronics Technology Co. ,Ltd., Shenzhen City, Guangdong (CN)

(21) Appl. No.: 13/518,868

(22) PCT Filed: Mar. 28, 2012
(86) PCT No.: PCT/CN12/73166

§ 371 Date: Jun. 22, 2012

(30) Foreign Application Priority Data
Mar. 19, 2012 (CN) 201210073190.0

(51) Int. Cl. H04N 5/00

(52) U.S. Cl. 211/26

(57) ABSTRACT

The present invention provides a carrier tray of a liquid crystal panel, which includes a tray body and magnetic sidewalls arranged along a circumference of the tray body. The tray body includes a bottom plate. The magnetic sidewalls are mounted to edges of the bottom plate. The bottom plate includes a support surface, which is concave. The concave support surface has a bottom location where a magnetic member is mounted. In assembling a liquid crystal module, a bolt that drops can be attracted and held by the magnetic member or the magnetic sidewalls, thereby preventing the bolt from dropping or falling into the equipment of a manufacture line to cause malfunctioning of the equipment and avoiding the maintenance expense and loss of throughput due to such malfunctioning, and at the same time improving the 6S of a clean room.

### BACKGROUND OF THE INVENTION

1. Field of the Invention

The present invention relates to the field of liquid crystal display manufacture, and in particular to a carrier tray of a liquid crystal panel used in a manufacture process of liquid crystal displays.

2. The Related Arts

A thin-film transistor (TFT) comprises a backlight module, a liquid crystal panel, and a front bezel. In the manufacture process of a liquid crystal display module, various jigs and fixtures are used, of which a carrier tray for liquid crystal panel is an important one. A conventional liquid crystal panel tray comprises a bearing device and a positioning device set at a center of the tray. The bearing device comprises two parallel and opposite walls between which a distance is set to correspond to the width of a product. The liquid crystal panel tray is mounted on a moving mechanism to receive a backlight module to be placed thereon. A liquid crystal panel is then disposed on the backlight module. The liquid crystal panel tray carries the liquid crystal panel to each workstation of a manufacture line to carry out corresponding operations. In a securing workstation, an operator needs to apply bolts to secure a bezel to the backlight module. Since the conventional liquid crystal panel tray is of a planar configuration, it often occurs that bolts may unexpected fall and roll out of the tray during the operation of tightening the bolts and this causes damage and loss of the bolts. The quantity of bolts used in the securing operation is quite great, and thus having bolt rolling out of the tray affects the 6S and also increases the expense of bolt, leading to economic loss. Since the liquid crystal panel tray is constantly moved along the manufacture line, once a bolt falls into equipment of the manufacture line would cause malfunction and fault of the equipment. This certainly increases the expense of maintenance and, in addition, shutting down the manufacture line greatly lowers the throughput of the manufacture line.

To handle such a problem, Chinese Patent Publication No. CN201072475 discloses a tray with bolt recovery feature, which comprises a bearing device and a positioning device and further comprises an anti-skid piece arranged along a circumference of the tray. Although adopting such a tray may, to some extents, preventing bolts from falling out of the tray, but the bolts may get dispersed inside the tray, making it hard for recovery. Especially for a large-sized tray that is used in assembling a large-sized liquid crystal display device, recovering the bolts that scatter around the tray one by one would cause a great waste of working hour. Apparently, further improvement is desired for the liquid crystal panel tray.

### SUMMARY OF THE INVENTION

An objective of the present invention is to provide a carrier tray of a liquid crystal panel, which has a simple structure and can facilitate recovery of bolt to effectively lower down cost.

To achieve the objective, the present invention provides a carrier tray of a liquid crystal panel, which comprises: a tray body and magnetic sidewalls arranged along a circumference of the tray body.

The tray body comprises a bottom plate, and the magnetic sidewalls are mounted to edges of the bottom plate. The bottom plate comprises a support surface, which is concave.

The support surface comprises a concave curved surface.

The carrier tray of a liquid crystal panel further comprises a magnetic member, which is mounted at a bottom location of the concave support surface.

The magnetic member is made of a magnet or a magnetic material.

The magnetic sidewalls are made of magnets or magnetic materials.

The tray body further comprises a bearing device, which is mounted on the support surface of the bottom plate.

The bearing device is fixed to the bottom plate by bolts.

The tray body further comprises a positioning device, which is mounted on the support surface of the bottom plate.

The positioning device is fixed to the bottom plate by bolts.

The efficacy of the present invention are that the present invention provides a carrier tray for a liquid crystal panel, which comprises a support surface having edges along which magnetic sidewalls are arranged and the support surface comprises a concave surface having a bottom location at which a magnetic member is mounted. In assembling a liquid crystal module, during a bolt tightening operation, a bolt that drops can roll toward the bottom location of the concave surface to be attracted and held by the magnetic member or a bolt may drop to edges of the concave surface and is attracted and held by the magnetic sidewalls, thereby preventing the bolt from dropping or falling into the equipment of the manufacture line to cause malfunctioning of the equipment and avoiding the maintenance expense and loss of throughput due to such malfunctioning, and at the same time improving the 6S of a clean room. After the manufacture, the bolts that are lost can be recovered for subsequent use thereby reducing waste and lowering manufacture cost.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, will be apparent from the following detailed description of an embodiment of the present invention, with reference to the attached drawings. In the drawings:

FIG. 1 is a top plan view of a carrier tray of liquid crystal panel according to the present invention; and

FIG. 2 is a cross-sectional view of an assembly of a bottom plate and sidewalls of the carrier tray of liquid crystal panel according to the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

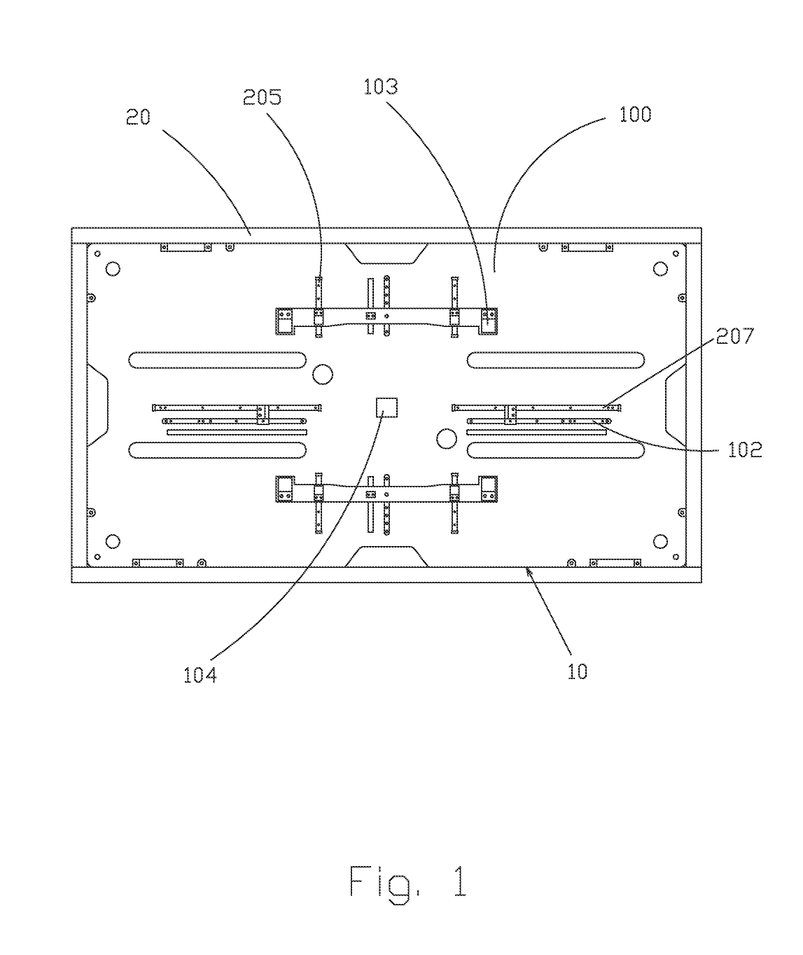

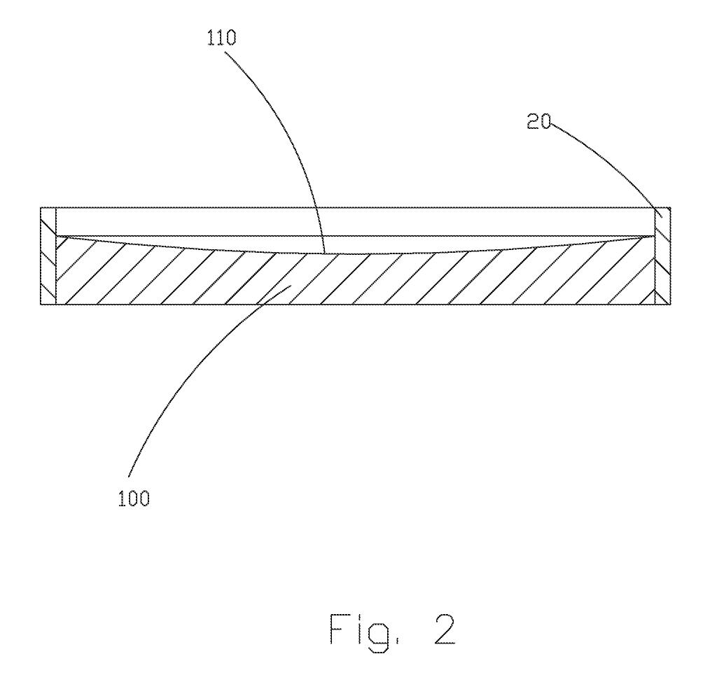

Referring to FIGS. 1 and 2, the present invention provides a carrier tray of a liquid crystal panel, which comprises: a tray body 10 and magnetic sidewalls 20 arranged along circumferential edges of the tray body 10. The tray body 10 comprises a bottom plate 100, a positioning device 102, a bearing device 103, and a magnetic member 104.

The bottom plate 100 is of for example a rectangular shape and comprises a support surface 110. The support surface 110 is a concave curved surface so that parts, such as bolts (not shown), falling onto the bottom plate 100 are subjected to gravity to roll to a central location of the concave support surface to easy retrieval.

The sidewalls 20 are mounted to edges of the bottom plate 100 and are of magnetism by being made of magnets or other magnetic materials. During a bolt tightening operation of assembling process of liquid crystal module, bolts falling around the circumference of the bottom plate 100 are held by being magnetically attracted by the magnetic sidewalls 20 so as to prevent the bolts from falling to the ground or falling into the nearby equipment.

The bearing device 103 is mounted on the support surface 110. The bearing device 103 is fixed to the bottom plate 100 by bolts or screws. In assembling the liquid crystal module, a backlight module (not shown) is positioned on the bearing device 103.

The magnetic member 104 is arranged at the center of the support surface 110 and is made of magnets or other magnetic materials to show magnetism in order to magnetically attract and thus hold bolts that rolls to the central location of the support surface 110. The magnetic member 104 has a height that is smaller than or substantially equal to height of the bearing device 103 to avoid undesired interference with bearing of the backlight module. Preferably, the height of the magnetic member 104 is smaller than that of the bearing device 103. The magnetic member 104 is mounted at a bottom location of the concave support surface 110.

The positioning device 102 is fixed on the bottom plate 100 by bolts or screws and comprises positioning bars 205, 207, which include S-side (source drive side) positioning bars 205 and G-side (gate drive side) positioning bars 207. Through holes (not shown) are formed in the S-side positioning bars 205 and the G-side positioning bars 207 at predetermined locations. The S-side positioning bars 205 are used to fix a product at a position in X-direction (horizontal direction) and the G-side positioning bars 207 are used to fix the product at a position in Y-direction (vertical direction). These predetermined locations are determined according to length and width of the product and the determination is made by first pacing the product on the bearing device 103 of the tray, followed by measuring lengthwise and width-wise edge dimension and making the through holes in the S-side positioning bars 205 and the G-side positioning bars 207. When the tray are put into use, S-side positioning blocks (not shown) and G-side positioning blocks (not shown) are respectively set on the S-side positioning bars 205 and the G-side positioning bars 207. The S-side positioning blocks and the G-side positioning blocks each have a side facing the backlight module and forming a pawl (not shown) for better holding the product and thus ensuring the position of the product on the tray is fixed and not variable.

The embodiment illustrated above is one of the preferred embodiments according to the present invention. In practical applications, based on the size of the bottom plate, the support surface may be formed by adjoining a plurality of concave curved facets each of which has a bottom location at which a magnetic member is mounted so that bolts that fall into the tray can be held in the concave curved facets.

In summary, the present invention provides a carrier tray for a liquid crystal panel, which comprises a support surface having edges along which magnetic sidewalls are arranged and the support surface comprises a concave surface having a bottom location at which a magnetic member is mounted. In assembling a liquid crystal module, during a bolt tightening operation, a bolt that drops can roll toward the bottom location of the concave surface to be attracted and held by the magnetic member or a bolt may drop to edges of the concave surface and is attracted and held by the magnetic sidewalls, thereby preventing the bolt from dropping or falling into the equipment of the manufacture line to cause malfunctioning of the equipment and avoiding the maintenance expense and loss of throughput due to such malfunctioning, and at the same time improving the 6S of a clean room. After the manufacture, the bolts that are lost can be recovered for subsequent use thereby reducing waste and lowering manufacture cost.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A carrier tray of a liquid crystal panel, comprising a tray body and magnetic sidewalls arranged along a circumference of the tray body, the tray body comprising a bottom plate, the magnetic sidewalls being mounted to edges of the bottom plate, the bottom plate comprising a support surface, which is concave.

2. The carrier tray of a liquid crystal panel as claimed in claim 1, wherein the support surface comprises a concave curved surface.

3. The carrier tray of a liquid crystal panel as claimed in claim 1 further comprising a magnetic member, which is mounted at a bottom location of the concave support surface.

4. The carrier tray of a liquid crystal panel as claimed in claim 3, wherein the magnetic member is made of a magnet or a magnetic material.

5. The carrier tray of a liquid crystal panel as claimed in claim 1, wherein the magnetic sidewalls are made of magnets or magnetic materials.

6. The carrier tray of a liquid crystal panel as claimed in claim 1, wherein the tray body further comprises a bearing device, which is mounted on the support surface of the bottom plate.

7. The carrier tray of a liquid crystal panel as claimed in claim 6, wherein the bearing device is fixed to the bottom plate by bolts.

8. The carrier tray of a liquid crystal panel as claimed in claim 1, wherein the tray body further comprises a positioning device, which is mounted on the support surface of the bottom plate.

9. The carrier tray of a liquid crystal panel as claimed in claim 8, wherein the positioning device is fixed to the bottom plate by bolts.
